(19) United States
(12) Patent Application Publication
(10) Pub. No.: US 2022/0381343 A1
(43) Pub. Date: Dec. 1, 2022

(54) Sealing Plug

(71) Applicant: ILLINOIS TOOL WORKS INC., Glenview, IL (US)

(72) Inventors: Jiahui HE, Shanghai (CN); Mengli SUN, Shanghai (CN)

(21) Appl. No.: 17/828,612

(22) Filed: May 31, 2022

(30) Foreign Application Priority Data
May 31, 2021 (CN) 202110601241.1
Apr. 20, 2022 (CN) 202210418312.9

(51) Int. Cl. F16J 15/02

(52) U.S. Cl. CPC F16J 15/022

(57) ABSTRACT

A sealing plug for sealing a hole in a plate to be sealed comprising: an operating part; a base body comprising a neck ring and a tapered ring, the neck ring comprises an annular sealing surface on an outer circumferential surface thereof, and the base body is configured to be movable towards or away from the operating part around a bottom part of the tapered ring; an upper support lip; and a lower support lip; the sealing plug is configured to seal the hole in the plate to be sealed through the annular sealing surface. The sealing plug forms a sealing structure by means of press fitting between a hole edge of the plate to be sealed and the annular sealing surface on the outer circumferential surface of the neck ring. The sealing structure of the sealing plug is irrelevant with the deformation of the upper support lip, and therefore does not affect an insertion force required to insert the sealing plug into the hole. The amount of interference between the hole edge of the plate to be sealed and the annular sealing surface of the sealing plug may be adjusted according to the requirement for a waterproof pressure.

### TECHNICAL FIELD

The present disclosure relates to a sealing plug, and in particular to a sealing plug for sealing a hole in a plate to be sealed.

### BACKGROUND

During the manufacture of a body of a vehicle, some holes are formed in a panel of a body structure and need to be sealed to prevent dust or water from entering. Sealing plugs are used for being inserted into these holes and form seals with the panel to be sealed.

### SUMMARY OF THE DISCLOSURE

At least one object of the present disclosure is to provide a sealing plug for sealing a hole in a plate to be sealed, the sealing plug comprising: an operating part; a base body arranged around the operating part, wherein the base body comprises a neck ring and a tapered ring, the neck ring comprises an annular sealing surface on an outer circumferential surface thereof, the top part of the tapered ring is connected to the bottom part of the neck ring, bottom part of the tapered ring is connected to the operating part, the tapered ring tapers from the top part to the bottom part of the tapered ring, and the base body is configured to be movable towards or away from the operating part around the bottom part of the tapered ring; an upper support lip arranged around the neck ring, and extending downward and in a direction away from the operating part from the top part of the neck ring; and a lower support lip arranged around the neck ring, and extending from a junction of the neck ring and the tapered ring in a direction away from the operating part; wherein the sealing plug is configured to seal the hole in the plate to be sealed through the annular sealing surface of the neck ring.

According to the foregoing content, the sealing plug has an axis, and the neck ring has a straight cylindrical shape extending along the axis of the sealing plug.

According to the foregoing content, the lower support lip has a top support surface extending along the radial direction of the sealing plug.

According to the foregoing content, a height of the annular sealing surface of the neck ring along the axis of the sealing plug is greater than a thickness of the plate to be sealed.

According to the foregoing content, the diameter of the annular sealing surface is greater than the diameter of the hole in the plate to be sealed.

According to the foregoing content, an outer surface of the lower support lip extends continuously with an outer surface of the tapered ring.

According to the foregoing content, the operating part comprises an inverted tapered ring and a cover closing the inverted tapered ring, wherein the bottom part of the inverted tapered ring is connected to the bottom part of the tapered ring, a top part of the inverted tapered ring is connected to the cover, and the inverted tapered ring tapers from the bottom part to the top part thereof.

According to the foregoing content, the operating part further comprises a plurality of ribs arranged in a receiving space inside the inverted tapered ring and connected to an inner surface of the operating part.

According to the foregoing content, the plurality of ribs are emanating outwardly from the axis of the sealing plug.

According to the foregoing content, the sealing plug is integrally made of an elastomeric material.

Other objects and advantages of the present disclosure will be apparent from the following description of the present disclosure with reference to the accompanying drawings, which can facilitate the comprehensive understanding of the present disclosure.

### BRIEF DESCRIPTION OF THE DRAWINGS

FIGS. 1A and 1B are structural perspective diagrams of a sealing plug according to the present disclosure from two perspectives;

FIG. 1C is a front view of the sealing plug shown in FIG. 1A;

FIG. 1D is a bottom view of the sealing plug shown in FIG. 1A;

FIG. 2A is a cross-sectional view of the sealing plug shown in FIG. 1D taken along line A-A;

FIG. 2B is a cross-sectional view of the sealing plug shown in FIG. 1D taken along line B-B; and

FIGS. 3A, 3B and 3C illustrate the process of inserting the sealing plug shown in FIG. 1A into a hole in a plate to be sealed.

### DETAILED DESCRIPTION OF EMBODIMENTS

Various specific implementations of the present disclosure will be described below with reference to the accompanying drawings which constitute part of this description. It should be understood that although the terms for indicating orientations, such as “front”, “rear”, “upper”, “lower”, “left”, “right”, “top”, “bottom”, “inner” and “outer”, are used in the present disclosure to describe structural parts and elements in various examples of the present disclosure, these terms are used herein only for ease of illustration and are determined based on the exemplary orientations shown in the accompanying drawings. Since the embodiments disclosed in the present disclosure can be disposed in different directions, these terms for indicating orientations are only illustrative and should not be considered as limitations.

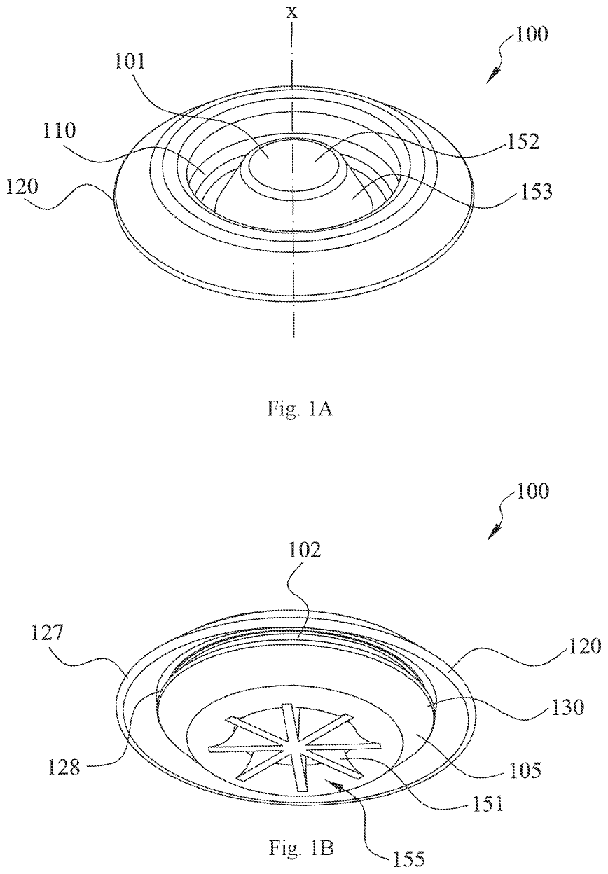

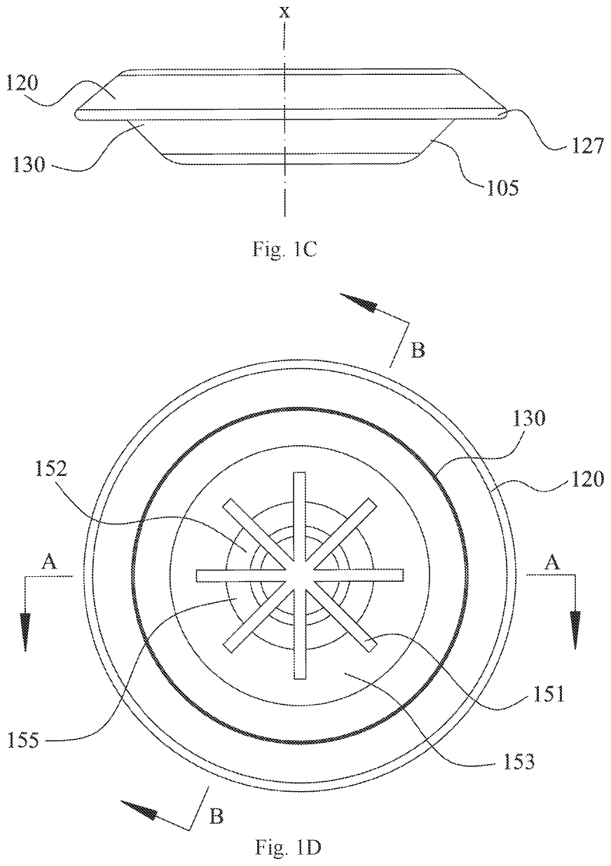

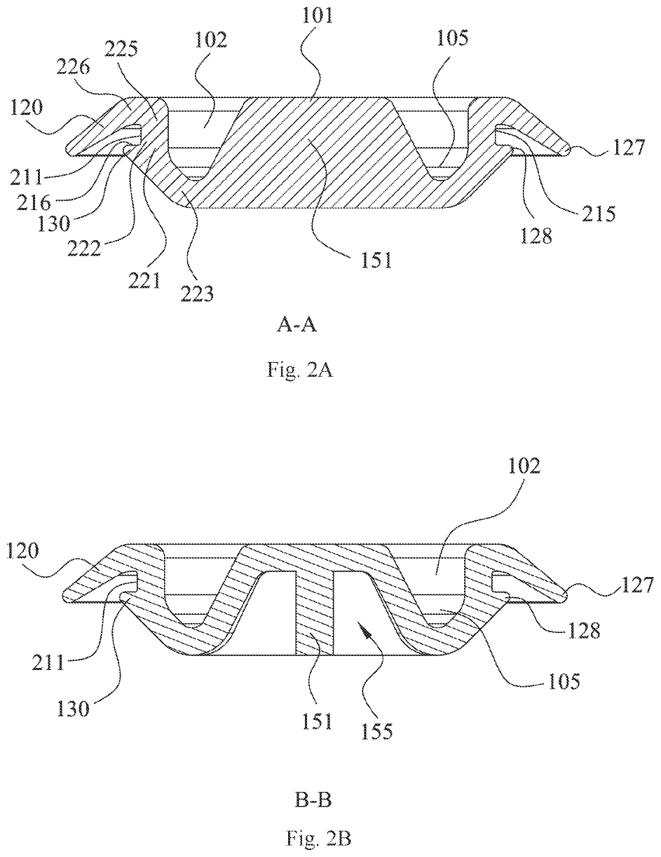

FIGS. 1A, 1B, 1C and 1D are structural schematic diagrams of a sealing plug 100 according to the present disclosure and are intended to illustrate a general structure of the sealing plug 100, wherein FIG. 1A shows a perspective diagram of the sealing plug 100 from top to bottom, FIG. 1B shows a perspective diagram of the sealing plug 100 from bottom to top, FIG. 1C shows a front view of the sealing plug 100, and FIG. 1D shows a bottom view of the sealing plug 100. FIGS. 2A and 2B are cross-sectional views of the sealing plug 100 along line A-A and along line B-B and are intended to illustrate a more detailed structure of the sealing plug 100.

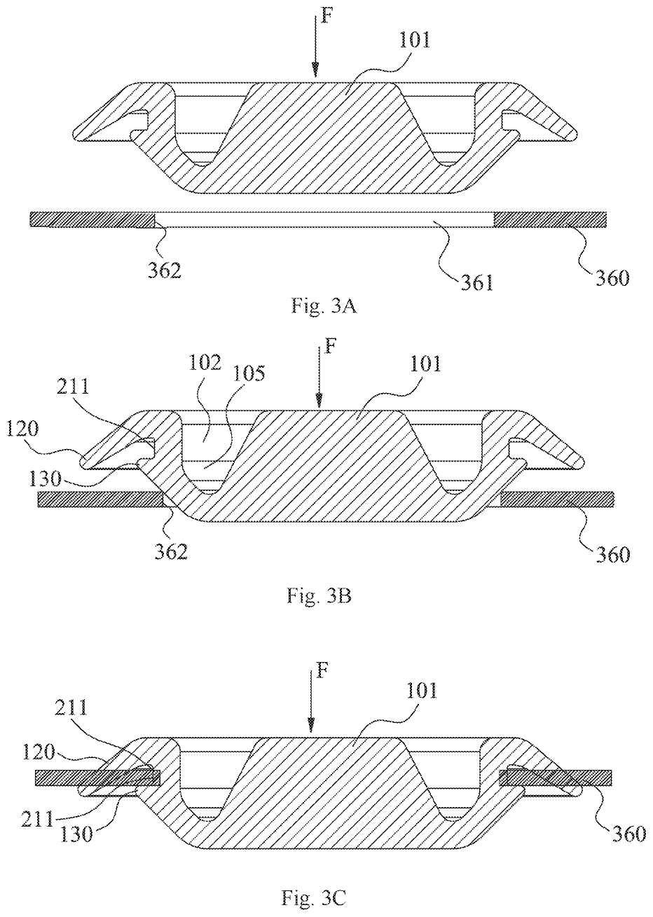

In this embodiment, the sealing plug 100 is used to be inserted into a hole 361 (shown in FIG. 3C) in a plate 360 to be sealed and seal the hole 361 (shown in FIG. 3C) in the plate 360 to be sealed. The sealing plug 100 is integrally made of an elastomeric material (for example, a TPE elastomeric material) by means of an injection molding process, and thus has a certain elasticity.

As shown in FIGS. 1A, 1B, 1C and 1D and FIGS. 2A and 2B, the sealing plug 100 is in a substantially axisymmetric shape with an axis x, and comprises an operating part 101 and a base body 110 arranged around the operating part 101, the bottom part of the base body 110 and the bottom part of the operating part 101 are connected to each other, and the upper part of the base body 110 is separated from the corresponding operating part 101 by a certain distance. For convenience of description below, the direction of the sealing plug 100 along the axis x is taken as an axial direction, the direction perpendicular to the axial direction is taken as a radial direction, and the direction around the axis is taken as a circumferential direction. The base body 110 comprises a neck ring 102 and a tapered ring 105 that are connected to each other, the neck ring 102 being arranged above the tapered ring 105.

The neck ring 102 is generally in the shape of a straight cylinder, which vertically extends in the axial direction and has a uniform thickness, in a direction from the top part 225 to the bottom part 222 thereof (namely, from top to bottom), the neck ring 102 has a peripheral surface 215 extending in the circumferential direction, and the peripheral surface 215 comprises an annular sealing surface 211. The annular sealing surface 211 is used for contact with a hole edge 362 of the hole 361 when the sealing plug 100 seals the hole 361 in the plate 360 to be sealed. When the neck ring 102 is subjected to an inward acting force, it deforms inwardly such that the annular sealing surface 211 and the hole edge 362 of the hole 361 in the plate 360 to be sealed are press-fitted with each other to form a seal (see FIG. 3C), thereby preventing dust, water and so on from penetrating from the upper side to the lower side of the plate 360 to be sealed through the hole 361. In this embodiment, a height of the annular sealing surface 211 in the axial direction is greater than a thickness of the plate 360 to be sealed, and the outer diameter of the annular sealing surface 211 is greater than the diameter of the hole 361.

The tapered ring 105 tapers towards the axis x in the axial direction from the top part 221 to the bottom part 223 thereof (namely, from top to bottom), so as to form a tapered ring. The top part 221 of the tapered ring 105 is connected to the bottom part 222 of the neck ring 102, and the bottom part 223 of the tapered ring 105 is connected to the operating part 101.

The sealing plug 100 further comprises an upper support lip 120 and a lower support lip 130, the upper support lip 120 and the lower support lip 130 being used for keeping the sealing plug 100 in place when the sealing plug 100 is inserted into the hole 361 (see FIG. 3C) in the plate 360 to be sealed. The upper support lip 120 is arranged around the neck ring 102 and located outside the neck ring 102 and is connected to the top part of the neck ring 102. The lower support lip 130 is also arranged around the neck ring 102 and located outside the neck ring 102 and is connected to the bottom part of the neck ring 102. Specifically, the upper support lip 120 is formed by extending outward from the top part 225 of the neck ring 102 to form a connecting portion 226, and then obliquely extending downward and in a direction away from the operating part 101 (namely, away from the axis x or outward) from the connecting portion 226, with a distal end 127 of the upper support lip 120 forming a free end. The lower support lip 130 is formed by extending from a junction of the neck ring 102 and the tapered ring 105 in the direction away from the operating part 101 (namely, away from the axis x or outward), with a distal end 128 of the lower support lip 130 forming a free end. That is to say, the upper support lip 120 and the lower support lip 130 each extend away from the axis x and form the free ends at their respective distal ends. Thus, both the upper support lip 120 and the lower support lip 130 can be elastically deformed to some extent. When the distal end 127 of the upper support lip 120 is subjected to an upward acting force, the upper support lip 120 can be deformed to some extent to move upward around the connecting portion 226. Also, when the distal end 128 of the lower support lip 130 is subjected to a downward acting force, the lower support lip 130 can also be deformed to some extent to move downward.

The lower support lip 130 has a top support surface 216, and in this embodiment, the top support surface 216 extends generally horizontally in the radial direction of the sealing plug 100 and is connected to an outer circumferential surface 215 of the neck ring 102. An annular sealing surface 211 is formed on the outer circumferential surface 215 between the top support surface 216 of the lower support lip 130 and the connecting portion 226 of the upper support lip 120. The top support surface 216 is used to abut against a lower surface of the plate 360 to be sealed so as to increase a pulling force required to pull out the sealing plug 100 from the plate 360 to be sealed, thus preventing the sealing plug 100 from undesirably dropping from the plate 360 to be sealed.

In the axial direction of the sealing plug 100, the distal end 127 of the upper support lip 120 extends downward beyond the distal end 128 of the lower support lip 130. Thus, when the plate 360 to be sealed is sandwiched between the upper support lip 120 and the lower support lip 130, at least one of the upper support lip 120 and the lower support lip 130 can be elastically deformed such that the upper support lip 120 can tightly abut against an upper surface of the plate 360 to be sealed, and the lower support lip 130 can tightly abut against the lower surface of the plate 360 to be sealed. In this embodiment, when the sealing plug 100 is inserted into the hole 361 in the plate 360 to be sealed, the upper support lip 120 can be deformed to some extent such that the upper support lip 120 tightly abuts against the upper surface of the plate 360 to be sealed and applies a restoring pressure to the upper surface of the plate 360 to be sealed. Also, the lower support lip 130 tightly abuts against the lower surface of the plate 360 to be sealed, in order to keep the plate 360 to be sealed between the upper support lip 120 and the lower support lip 130, thus keeping the sealing plug 100 in place.

In the radial direction of the sealing plug 100, the outer diameter of the distal end 128 of the lower support lip 130 is smaller than that of the distal end 127 of the upper support lip 120 but is greater than the diameter of the hole 361 in the plate 360 to be sealed. In this embodiment, an outer surface of the lower support lip 130 and an outer surface of the tapered ring 105 extend continuously. In this way, when the outer surface of the lower support lip 130 is subjected to an acting force in a direction of the axis x (namely, inward), the lower support lip 130 can be deformed inwardso as to make the base body 110 deform to move inward. Therefore, when the sealing plug 100 is inserted into the hole 361, the lower support lip 130 can be deformed inward due to the pressure from the hole edge 362 of the hole 361, and drives the base body 110 to generally move around the bottom part of the tapered ring 105 towards the operating part 101. After the distal end 128 of the lower support lip 130 goes over the hole 361, the base body 110 generally moves around the bottom part of the tapered ring 105 in the direction away from the operating part 101.

The operating part 101 is convenient for an operator to apply a pressure to the sealing plug 100 such that the sealing plug 100 can be inserted into the hole 361 in the plate 360 to be sealed. The operating part 101 is substantially in the shape of an inverted bowl and comprises an inverted tapered ring 153 and a cover 152 covering the inverted tapered ring 153. The bottom part of the inverted tapered ring 153 is connected to the bottom part 223 of the tapered ring 105, and the top part of the inverted tapered ring 153 is connected to the cover 152. The inverted tapered ring 153 tapers towards the axis x in the axial direction from the bottom part to the top part thereof so as to form a tapered shape. That is to say, the inverted tapered ring 153 tapers in a direction opposite to the direction in which the tapered ring 105 tapers. Thus, the bottom part of the inverted tapered ring 153 can be connected to the bottom part of the tapered ring 105, and the upper portion of the bottom part of the inverted tapered ring 153 can be spaced from the top part of the tapered ring 105 and the neck ring 102 by a certain distance so as to provide a space for inward movement of the base body 110.

The bottom part of the operating part 101 is in a hollowed-out shape, and has a receiving space 155. The operating part 101 further comprises a plurality of ribs 151, these ribs 151 being arranged in the receiving space 155 and connected to an inner surface of the operating part 101. These ribs 151 are used to support the inverted tapered ring 153 of the operating part 101 so as to prevent the inverted tapered ring 153 from being deformed when an external force is applied thereto, for example, to prevent the operating part 101 from being overturned and deformed downward when the top part of the operating part 101 is subjected to a downward pressing force applied by the operator. In this embodiment, the number of ribs 151 is set as eight, and these ribs are uniformly distributed in the receiving space 155 and are emanating outwardly from the axis x.

FIGS. 3A, 3B and 3C illustrate the process of inserting the sealing plug 100 into the hole 361 in the plate 360 to be sealed so as to close the hole 361. As shown in FIG. 3A, the operator first aligns the sealing plug 100 with the hole 361 in the plate 360 to be sealed, and then applies a downward pressure F to the operating part 101 such that the sealing plug 100 is inserted downward into the hole 361 in the plate 360 to be sealed until the position as shown in FIG. 3B is reached.

As shown in FIG. 3B, the lower support lip 130 of the sealing plug 100 abuts against the hole edge 362 of the hole 361. When the operator continues to apply the downward pressure F, the lower support lip 130 is pressed by the hole edge 362, the lower support lip 130 first makes the whole base body 110 be substantially deformed inward in the radial direction such that the outer diameter of the lower support lip 130 can be decreased to equal to the diameter of the hole 361, and the lower support lip 130 can then continue to move downward to go over the hole edge 362 of the hole 361. During the downward movement of the lower support lip 130, the distal end 127 of the upper support lip 120 first abuts against the upper surface of the plate 360 to be sealed, and then as the lower support lip 130 moves downward, the upper support lip 120 is deformed upward until the position shown in FIG. 3C is reached.

As shown in FIG. 3C, the lower support lip 130 of the sealing plug 100 goes over the hole edge 362 of the hole 361 and is no longer pressed by the hole edge 362 such that the base body 110 can substantially move outward in the radial direction. Since the outer diameter of the annular sealing surface 211 on the base body 110 is greater than the diameter of the hole 361, when the base body 110 moves outward until the annular sealing surface 211 contacts and presses against the hole edge 362 of the hole 361, the base body 110 stops moving outward, and in this case, the annular sealing surface 211 can be press-fitted with the hole edge 362 of the hole 361 to form a seal, and the sealing plug 100 cannot continue to move in the radial direction thereof. The distal end 127 of the upper support lip 120 tightly abuts against the upper surface of the plate 360 to be sealed and applies a downward pressure to the plate 360 to be sealed, the top support surface 216 of the lower support lip 130 tightly abuts against the lower surface of the plate 360 to be sealed, and the sealing plug 100 cannot continue to move in the axial direction thereof. Therefore, the sealing plug 100 can be securely kept in the hole 361 in the plate 360 to be sealed and seal the hole 361.

One of existing sealing plugs forms a sealing structure by means of mutual press fitting between the upper support lip and the plate to be sealed. However, such a sealing structure is not stable, and when a water pressure above the plate to be sealed is excessively large, water may seep out of the sealing structure and flows out through the hole to the lower part of the plate to be sealed. If the stability of the sealing structure is increased by strengthening the upper support lip (for example, increasing the amount of interference between the upper support lip and the plate to be sealed), it will be difficult to deform the upper support lip so that an insertion force required to insert the sealing plug into the hole in the plate to be sealed is excessively large.

Another existing sealing plug forms a sealing structure by applying a hot melt adhesive between the upper support lip and the plate to be sealed. Although such a sealing structure has a better stability, heating is required to melt the hot melt adhesive after a sealing member has been inserted into the hole in the plate to be sealed. On the one hand, some production processes may not allow reheating after the sealing plug has been inserted into the hole, and on the other hand, the cost of such a sealing plug is high.

In addition, the sealing plug of the present disclosure forms the sealing structure by means of the mutual press fitting between the hole edge of the plate to be sealed and the annular sealing surface on the outer circumferential surface of the neck ring. In one aspect, the sealing structure of the sealing plug of the present disclosure is irrelevant with the deformation of the upper support lip, and therefore does not affect the insertion force required to insert the sealing plug into the hole. In the other aspect, the amount of interference between the hole edge of the plate to be sealed and the annular sealing surface of the sealing plug may be adjusted according to the requirement for a waterproof pressure, for example, the waterproof requirement for a water depth of 500 mm may be met. Furthermore, the sealing plug of the present disclosure is provided with a plurality of ribs in the operating part, so that the operator can apply a pressure to the sealing plug through the operating part without deforming the operating part, which is more convenient for the operator to operate.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, this disclosure is intended to embrace all known or earlier disclosed alternatives, modifications, variations, improvements, and/or substantial equivalents.

What is claimed is:

1. A sealing plug, the sealing plug being used for sealing a hole in a plate to be sealed, the sealing plug comprising:
an operating part;
a base body arranged around the operating part, wherein the base body comprises a neck ring and a tapered ring, the neck ring comprises an annular sealing surface on an outer circumferential surface thereof, the top part of the tapered ring and the bottom part of the neck ring is connected, the bottom part of the tapered ring is connected with the operating part, the tapered ring tapers from the top part to the bottom part of the tapered ring, and the base body is configured to be movable towards or away from the operating part around the bottom part of the tapered ring;
an upper support lip arranged around the neck ring, and extending downward and in a direction away from the operating part from the top part of the neck ring; and
a lower support lip arranged around the neck ring, and extending in a direction away from the operating part from a junction of the neck ring and the tapered ring;
wherein the sealing plug is configured to seal the hole in the plate to be sealed through the annular sealing surface of the neck ring.

2. The sealing plug of claim 1, wherein:
the sealing plug has an axis (x), and the neck ring has a straight cylindrical shape extending along the axis (x) of the sealing plug.

3. The sealing plug of claim 1, wherein:
the lower support lip has a top support surface extending along the radial direction of the sealing plug.

4. The sealing plug of claim 1, wherein:
a height of the annular sealing surface of the neck ring on the axis (x) of the sealing plug is greater than a thickness of the plate to be sealed.

5. The sealing plug of claim 1, wherein:
the diameter of the annular sealing surface is larger than diameter of the hole of the plate to be sealed.

6. The sealing plug of claim 1, wherein:
an outer surface of the lower support lip extends continuously with the outer surface of the tapered ring.

7. The sealing plug of claim 1, wherein:
the operating part comprises an inverted tapered ring and a cover covering the inverted tapered ring, wherein the bottom part of the inverted tapered ring is connected to the bottom part of the tapered ring, the top part of the inverted tapered ring is connected to the cover, and the inverted tapered ring tapers from the bottom part to the top part thereof.

8. The sealing plug of claim 7, wherein:
the operating part further comprises a plurality of ribs arranged in a receiving space (155) inside the inverted tapered ring and connected to an inner surface of the operating part.

9. The sealing plug of claim 8, wherein:
the plurality of ribs is emanating outwardly from the axis (x) of the sealing plug.

10. The sealing plug of claim 1, wherein:
the sealing plug is integrally made of an elastomeric material.
